(19) United States
(12) Patent Application Publication
(10) Pub. No.: US 2011/0312424 A1
(43) Pub. Date: Dec. 22, 2011

(54) Peer to Peer Video Game Clip Sharing

(75) Inventors: Erik John Burckart, Raleigh, NC (US); Andrew Ivory, Wake Forest, NC (US); Mark Anthony Parazygnat, Raleigh, NC (US); Aaron Kyle Shook, Raleigh, NC (US)

(73) Assignee: International Business Machines Corp., Armonk, NY (US)

(21) Appl. No.: 12/820,775

(22) Filed: Jun. 22, 2010

(51) Int. Cl. H04N 5/91; G06F 15/16; A63F 13/12

(52) U.S. Cl. 463/42; 709/204; 725/109

(57) ABSTRACT

The present invention provides a method, system, and program product for automatically sharing video clips of video game action. A video capture application sets game action triggers for video clip capture. The video sharing application automatically captures a video clip during a video game in response to triggering actions during playing of a game. The video sharing application automatically tags recipients. Then, the video sharing application automatically sends the captured video clip to the tagged recipients.

### FIELD OF THE INVENTION

The invention relates to the field of video games and more particularly to a method, system and computer program product for enabling a player to automatically create and share video clips of game action.

### BACKGROUND

Video games have become increasingly popular over time. One area of video games that is rapidly increasing in popularity is interactive on-line gaming, in which multiple game players at different locations play interactively over a network, such as the Internet. Different game players, each at their own console or station, connect through a network server to play in real time and interactively.

In video games, the players dictate the movements and actions of their virtual selves, called avatars, in a virtual environment by combinations of controls on a controller. The controls may include joysticks, buttons, and motion of the controller, itself, such as tilting, raising, twisting, and the like. The player manipulates the controls to create a controller input which is transmitted to the player's console.

In interactive on-line games, the controller inputs are transmitted over a network to a game server which receives controller inputs from a plurality of players and resolves action between players' avatars and other players' avatars, as well as features of the game such as non-character players (NCPs), forces acting on the avatars such as gravity, and objects and obstacles in the game, and the like. The resolved actions are transmitted back to the consoles, which create a video of the action from the player's avatar's perspective and present the video at a monitor connected to the console.

In many video games, including those for which interactive on-line play is available, increasing numbers of players are interested in sharing video clips of their game play with others. Currently, this is a difficult process requiring manual capture of game action and manual posting to a video sharing web page. To manually capture video clips of game action, typically a game player requires additional equipment to intercept the video signal being sent to the monitor and knowledge of how to connect the hardware and capture video signals. Moreover, the player wishing to share video clips of game action must notify those whom he/she wishes to share the video clip with of its existence and location.

### SUMMARY

It is advantageous for a video game system to automatically capture video clips of game action and to automatically share the game clips with others. It is also advantageous for a game player to select what game actions are captured as video clips and how the video clips are shared. According to embodiments of the present invention a method, system, and program product are provided for automatically sharing video clips of video action based on a player's preferences.

According to one embodiment a method is provided for sharing video clips of video game action. A video sharing application sets game action triggers for video clip capture. The video sharing application automatically captures a video clip during a video game in response to the occurrence of triggering actions during playing of a game. The video sharing application automatically tags recipients. Then, the video sharing application automatically sends the captured video clip to the tagged recipients.

Tagging recipients may comprise at least one other player in the game being automatically tagged as a recipient based on player selected parameters or preferences. The other player may be tagged as a recipient using the other player's display name. Alternatively, the other player in the game may be tagged as a recipient by querying the server for player information. One or more individuals not participating in the game may also be tagged as a recipient based on player selected parameters.

According to one embodiment, the video clip is created by a winner of the video game and is automatically sent to the tagged recipients between games.

According to another embodiment the video clip is automatically sent to the tagged recipients after the video game for later viewing.

According to another embodiment the video clip is automatically uploaded to a file-sharing web site and a link to the video clip is automatically sent to the tagged recipients.

According to another embodiment the video clip is automatically sent to the tagged recipient's mobile devices as a multimedia messaging service (MMS) message after the video game.

According to an embodiment of the present invention a system is provided for sharing video clips of video game action. The system comprises: a processor processing player input and game action and creating video of the game action; a memory operably connected to the processor and having stored thereon player selected settings for triggering video clip capture and settings for sharing video clips; a memory operably connected to the processor and having a video clip sharing application encoded thereon. The video clip sharing application automatically captures video clips in response to game actions meeting the triggering settings and automatically shares the video clips according to the sharing settings.

According to one embodiment of the present invention, the processor is a processor of a game server connected through a network to a plurality of game consoles. According to another embodiment, the processor is a processor of a game console connected through a network to a game server.

According to an embodiment of the present invention, a program product is provided for sharing video clips of video game action. The program product comprises a computer readable storage medium having encoded thereon a program of instructions. The program of instructions comprise: program instructions for setting game action triggers for video clip capture; program instructions for automatically capturing a video clip during a video game in response to triggering actions during playing of a game; program instructions for automatically tagging recipients; and program instructions for automatically sending the captured video clip to the tagged recipients.

### BRIEF DESCRIPTION OF THE DRAWINGS

The features and advantages of the invention will be more clearly understood from the following detailed description of the preferred embodiments when read in connection with the accompanying drawing. Included in the drawing are the following figures:

FIG. 1 is a block diagram of a plurality of gaming consoles connected to a game server for interactive play, with the game console configured to automatically create and share video clips with other players according to an embodiment of the present invention;

FIG. 2 is a diagram showing a method for automatically tagging recipients to share video clip of game action according to an embodiment of the present invention; and

FIG. 3 is a diagram showing a method for automatically sharing a video clip according to an embodiment of the present invention;

FIG. 4 is a diagram showing a method for automatically sharing a video clip according to another embodiment of the present invention;

FIG. 5 is a diagram showing a method for automatically sharing a video clip according to another embodiment of the present invention;

FIG. 6 is a flow diagram of a method at a game console for automatically creating and sharing video clips from an interactive, multi-player game according to an embodiment of the present invention.

### DETAILED DESCRIPTION

The present invention provides a method, apparatus and program product for automatically creating and sharing a video clip from a video game. According to one embodiment, a player selects settings, or player preferences, for determining triggering events. Settings or preferences may also be set for determining who to tag as recipients and determining how and when video clips will be sent to the tagged recipients. During interactive, game play, in response to a triggering event, a video sharing application captures video of game action. The video sharing application tags recipients and shares the captured video clip with the tagged recipients according to the player selected preferences. In an alternative embodiment, default settings may be used for one or more of selecting triggering events, determining who to tag and determining how and when to send the video clip to the tagged recipients.

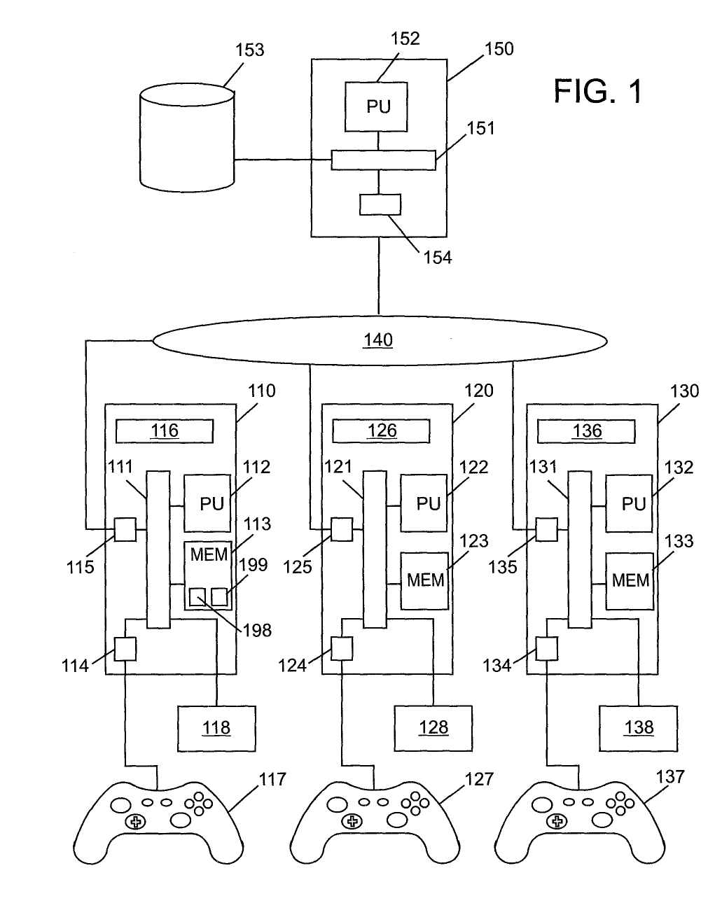

FIG. 1 is a block diagram of a game system set up for interactive multi-player gaming and for automatically creating and sharing video clips according to an embodiment of the present invention. Each player has a game console 110, 120, 130. The game console may be a game platform, a personal computer, or another electronic device configured for game play. The game console comprises a processing unit 112 for processing controller inputs and game features, resolving actions, and generating video of the game action. The processing unit 112 may be any suitable hardware, software, or combination thereof. According to one embodiment, the processing unit comprises one or more microprocessors.

A memory 113 is connected with the processing unit 112 through a bus 111. Memory 113 may comprise Random access Memory (RAM), persistent memory, such as a hard drive, a CD-ROM, a DVD drive, a USB memory device, or the like, or a combination thereof.

A game drive 116 is connected with the processing unit 112 through the bus 111. The game drive 116 may be a hard drive with a game loaded on it or a memory drive configured to receive a game disc or other memory device with a game encoded thereon. The game drive provides game features to the processing unit 112. Game features may include, but are not limited to: the appearance, location, and behavior of a game environment, appearance of a player's avatar, rules for interaction between the player's avatar and the game features, and rules for interpretation of controller inputs.

A controller interface 114 is also connected with the processing unit 112 through the bus 111. The controller interface 114 receives controller inputs in the form of electromagnetic signals from a controller 117, and transmits them through the bus 111 to the processing unit 112. The controller interface 114 may be connected to the controller 117 through wires or may be operably connected through transmission and receiving of wireless signals.

The controller 117 is configured with one or more controls, including but not limited to: joysticks, buttons, and movement sensors like accelerometers. A player manipulates the various controls and/or the controller itself to create controller inputs which are interpreted by the processing unit 112 under controller rules provided by the game disc as actions within the game. Control inputs may comprise combinations of control manipulations performed simultaneously or in particular sequences. Moreover, actions may be related to other actions to form more complex actions when performed in particular relationships with each other.

A monitor 117 is also connected with the processor 112 through the bus 111. The processor 112 processes the game features and the controller inputs to resolve game action and creates a video of the game action. The video is sent to the monitor 117 through the bus 111 and displayed on the monitor 117 for the player to view.

In an on-line version of the game, the console 110 is connected to a game server 150 through a network 140 and a network interface 115. The network 140 may be the Internet, an intranet or any other network suitable for providing communication between client consoles and a server. The network interface 115 may be an Ethernet card, or any other interface suitable for connecting to a network. The network interface is connected to the processing unit 112 through bus 111.

The server 150 comprises a processing unit 152. In the on-line version of the game, controller inputs are sent by the console 110 to the server 150, and the server processing unit 152 processes controller inputs and game features, and resolves actions. Video of the game action may be created at the server processing unit 152 or the console processing unit 112. The server processing unit 152 may be any suitable hardware, software, or combination thereof. According to one embodiment, the processing unit comprises one or more microprocessors.

The server may further comprise a memory 153 which may be internal to the server or may be an external memory device. The memory 153 is connected with the server processing unit 152 through a bus 151. A plurality of consoles 110, 120, 130 are connected to the server processing unit through a network 140 and a network interface 154 in the server 150.

According to one embodiment, a video game player desiring to share clips of video game action from his/her game sets sharing preferences 198, using a video sharing application 199 encoded on memory 153 in his/her console 110, on game server memory 153, or a combination of the two. These preferences may include actions that the player wants to trigger video capture, such as the player defeating another player, the player passing another player, a scoring play, a specific move or combination of moves, or the like. The preferences may also indicate who to share a video clip with, such as the other players in the game, the other players on his/her team, or the player whom he/she has just defeated, passed, or the like. The player preference for whom to share a video clip with may also include individuals not in the game, such as a friends list, for example. The preferences may also indicate how and when the video clip is shared, such as by uploading the video clip to tagged recipients' consoles after the game for viewing by the recipients at their discretion. Alternatively, the video clip may be streamed to the recipients' monitors for viewing between games. According to another alternative embodiment, the video clip may be uploaded to a video sharing web site and a link for the video clip may be sent to the recipients through the game system message system, email, instant messaging, or other communication platform. According to other embodiments, one or more of the preference settings are not set by the player, but are default settings programmed by the game manufacturer.

The console processor 112 executes program steps of the video sharing application 199, which enables the player to set preferences 198 for determining trigger events, tagging recipients, and determining sharing methods and timing. This may be accomplished, for example, using a user interface, such as a menu or dialog box displayed on the monitor 118 for the first console 110. The player preference settings 198 are stored in memory 113 on the console. This may be the same memory where the video sharing application is stored, as illustrated. Or it may be a different memory.

Then, during game play, the console processor 112 executes program steps of the video sharing application 199 to compare game action to the set trigger events to determine whether or not to capture video. In response to game action matching the trigger settings, the video application 199 captures a video clip of the game action. In one embodiment, the player inputs and game features are put in a cache so that the game action can be captured at least a few seconds after it is processed and displayed to the players. The video sharing application 199 then sends the captured video clip to the tagged recipients according to the player preference settings.

While the illustrated application shows the video sharing application 199 on a memory 113 in a console 110, in an alternate embodiment with game action resolved by a game server 150, the video sharing application may be on a memory 153 in or connected to the server 150. In this embodiment, a processor 152 in the server executes the program steps of the video sharing application 199. The player preference settings 198 in this embodiment may be stored on the server memory ort the console memory.

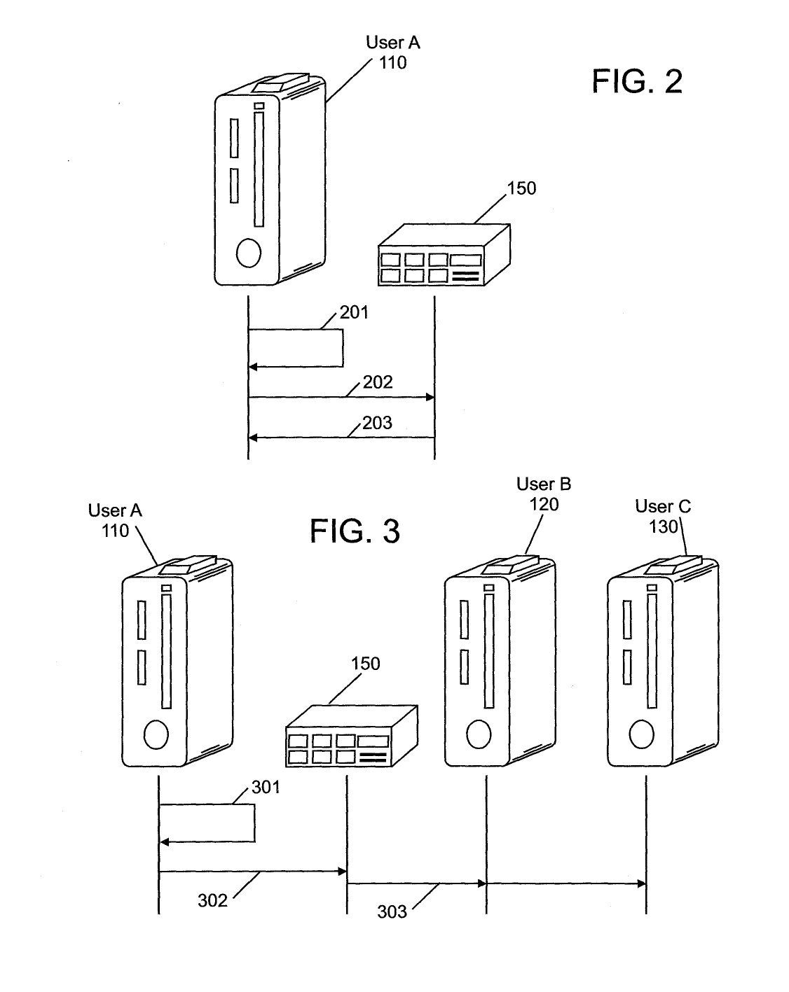

FIG. 2 is a diagram showing a method for tagging recipients to share video clips of game action with according to an embodiment of the present invention. Program instructions from the video sharing application 199 are triggered by a match of game action to trigger event according to player preferences (step 201). The program instructions identify players to be tagged. The video sharing application 199 may tag all other players in the game, other players on a team, players on a friend list whether or not they are participating in the current game, or any other desired individual or group. The recipients may be tagged according to player preferences that are set for the player capturing and sharing the video clip, or they may be default settings.

According to one embodiment, the video sharing application 199 causes the console 110 to query the game server 150 for information on one or more other players that meet player preferences (step 202). This information may be, for example, the network address of the consoles 120, 130 of other players participating in the game, email addresses for other players participating in the game, or any other information that enables the video sharing application 199 to identify where to send the video clip. The game server 150 returns the requested information to the console 110 (step 203), and the video sharing application 199 uses the information to tag the recipients. Alternatively, the video sharing application can capture the display names for other game participants, and use the display names to address the video clip.

FIG. 3 is a diagram showing a method for sharing a video clip of game action according to an embodiment of the present invention. In this embodiment, a video clip of the game winner is sent to the tagged recipients for display between games. A first player, user A, wins the game (step 301). The first player's console 110 has captured a video clip of game action according to the first player's preferences. The first player's console 110 sends the video clip to the recipient through the game server 150. The first player's console 110, executing the video sharing application 199 sends the video clip to the game server 150 (step 302). The video clip includes the recipient information tag. The game server then sends the video clip to the recipients to display between games (step 303).

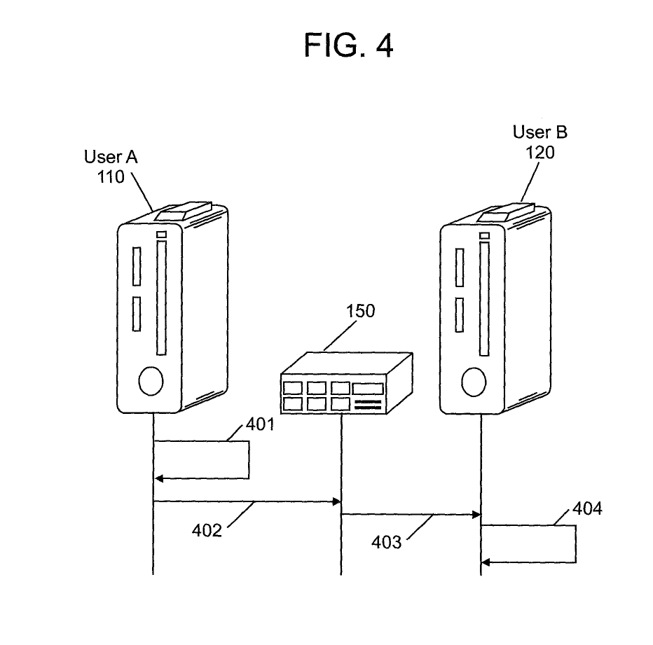

FIG. 4 is a diagram showing a method for sharing a video clip of game action according to another embodiment of the present invention. In this embodiment, a video clip of a first player is sent to the tagged recipients after the game for display at the recipient's discretion. When the game ends (step 401), the video sharing application 199 executing on the first player's console 110 sends the video clip to the game server 150 (step 402). The video clip includes the recipient information tag. The game server 150 then sends the video clip to the consoles 120, 130 of the recipients where they are stored in console memory 123, 133 (step 403). The recipients view the video clip from console memory 123, 133 at a time of their choosing (step 404). According to another embodiment, based on contact preferences, the game server 150 automatically sends the video clip to the tagged recipient's mobile devices as a multimedia messaging service (MMS) message after the video game.

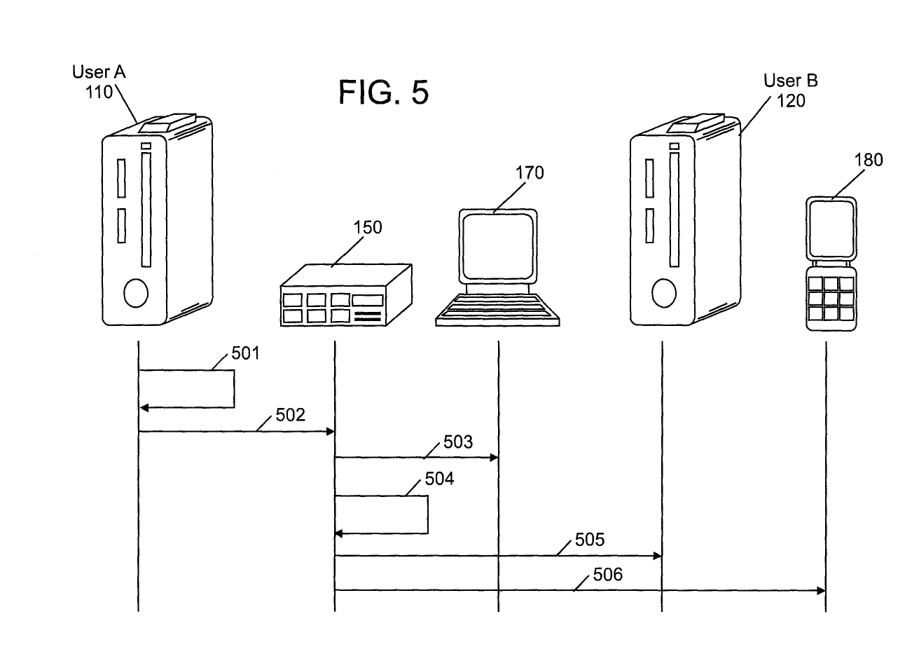

FIG. 5 is a diagram showing a method for sharing a video clip of game action according to another embodiment of the present invention. In this embodiment, a video clip of a first player is posted to a video sharing web site 170 and the video sharing application 199 sends a link to the recipients. When the game ends (step 501), the video sharing application 199 executing on the first player's console 110 sends the video clip to the game server 150 (step 502). The video clip includes the recipient information tag. The game server 150 then posts the video clip to a video sharing web site 170 using the first player's account information (step 503). The game server queries profiles for the recipients to determine their respective message preferences (step 504). In this embodiment, each player creates a profile, which may include their preference for receiving messages. The players may choose, for example, to receive messages on their game server account, through an instant messaging account, or through a cellular phone internet account.

The game server 150 sends the video clips to the recipient devices identified in the player preferences. In the illustrated embodiment, player B has preferences set to the game server's internal messaging system, and the game system server 150 sends player B a message over this internal messaging system comprising the link to the posted video clip (step 505). Also in the illustrated embodiment, player C has preferences set to a cell phone email account, and the game server 150 sends player C a message on his/her cell phone 180 comprising the link to the posted video clip (step 506).

In the foregoing examples, the video sharing application 199 is disposed in the first console 110. However, embodiments of the invention may be practiced in which the video sharing application 199 is disposed in the game serve 150, or in which the video sharing application comprises two parts with one part disposed in the first console 110 with program instructions for capturing a video clip of game action and instructions for tagging a recipient and another part is disposed in the game server 150 with program instructions for determining mail preferences, or other sharing preferences and sending the video clip and, if applicable, a link to a recipient according to those preferences.

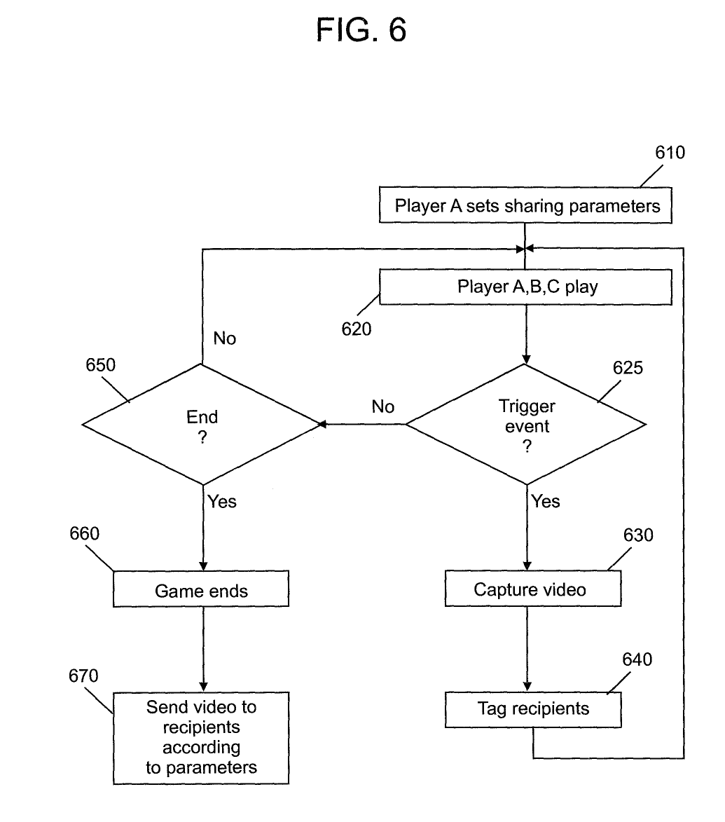

FIG. 6 is a flow diagram of a method for automatically sharing video clips of game action. Prior to game play, a first player, Player A, sets sharing parameters (step 610). As previously described, the sharing parameters may comprise: actions or events in the game that the player wants to trigger a video clip capture, such as scoring, player A defeating anther player, an the like; criteria for determining recipients to tag, such as other players in the game, players on player A's team, a friends list, or the like; how and when to share the video clip, such as streaming the video clip to recipients between games, sending the video to a recipient's console after the game for storage and viewing at a later time; and posting to a video sharing web site and sending a link to the video clip after the game.

Then, players A, B, and C begin a game (step 620). It should be understood that the invention is not limited to a specific number of players, and that any number of players from a solo player to a plurality of players numbering in the hundreds or more may play a game in various embodiments of the present invention.

During game play, the video sharing application 199 compares game action to parameters for triggering a video clip capture (step 625). If the game action matches the trigger in player A's preferences, then program instructions of the video sharing application 199 are executed to capture a video clip (step 630). This may be accomplished, for example, by saving game action from a cache to a memory.

The video sharing application also tags recipients (step 640). Recipients may be tagged according to user preferences as described above. According to one embodiment at least one other player in the game is automatically tagged as a recipient based on player selected parameters. The other player in the game may be tagged as a recipient using the other player's display name. Alternatively, the other player in the game may be tagged as a recipient by querying the server for player information. According to another embodiment, at least one individual not participating in the game may be tagged as a recipient based on player selected parameters.

Play continues (step 620) and the video sharing application 199 continues to monitor for triggering events (step 625).

During game play, the video sharing application monitors for a game end (step 650). If the game has not ended, game play continues (step 620). If a game end condition has occurred, the game ends (step 660) and the video sharing application sends the captured video clip to the tagged recipients according to player preferences (step 670).

The invention can take the form of an entirely hardware embodiment, an entirely software embodiment or an embodiment containing both hardware and software elements. In an exemplary embodiment, the invention is implemented in software, which includes but is not limited to firmware, resident software, microcode, etc.

Furthermore, the invention may take the form of a computer program product accessible from a computer-usable or computer-readable medium providing program code for use by or in connection with a computer or any instruction execution system or device. For the purposes of this description, a computer-usable or computer readable medium may be any apparatus that can contain or store the program for use by or in connection with the instruction execution system, apparatus, or device.

The foregoing method may be realized by a program product comprising a machine-readable medium having a machine-executable program of instructions stored on it, which when executed by a machine, such as a computer, performs the steps of the method. This program product may be stored on any of a variety of known machine-readable storage mediums, including but not limited to compact discs, floppy discs, USB memory devices, and the like.

The storage medium can be an electronic, magnetic, optical, electromagnetic, infrared, or semiconductor system (or apparatus or device). Examples of a computer-readable storage medium include a semiconductor or solid state memory, magnetic tape, a removable computer diskette, a random access memory (RAM), a read-only memory (ROM), a rigid magnetic disk an optical disk. Current examples of optical disks include compact disk-read only memory (CD-ROM), compact disk-read/write (CD-R/W) and DVD.

The preceding description and accompanying drawing are intended to be illustrative and not limiting of the invention. The scope of the invention is intended to encompass equivalent variations and configurations to the full extent of the following claims.

What is claimed is:

1. A method for sharing video clips of video game action comprising the steps of:
setting game action triggers for video clip capture;
automatically capturing a video clip during a video game in response to triggering actions during playing of a game;
automatically tagging recipients; and
automatically sending the captured video clip to the tagged recipients.

2. The method of claim 1, wherein at least one other player in the game is automatically tagged as a recipient based on player selected parameters.

3. The method of claim 2, wherein at least one other player in the game is tagged as a recipient using the other player's display name.

4. The method of claim 2, wherein at least one other player in the game is tagged as a recipient by querying the server for player information.

5. The method of claim 1, wherein at least one individual not participating in the game is tagged as a recipient based on player selected parameters.

6. The method of claim 1, wherein the game play comprises playing an interactive video game with other players over a network.

7. The method of claim 1, wherein the video clip is created by a winner of the video game and is automatically sent to the tagged recipients between games.

8. The method of claim 1, wherein the video clip is automatically sent to the tagged recipients after the video game.

9. The method of claim 1, wherein the video clip is automatically uploaded to a file-sharing web site and a link to the video clip is automatically sent to the tagged recipients.

10. The method of claim 1, wherein the video clip is automatically sent to the tagged recipient's mobile devices as a multimedia messaging service message after the video game.

11. A system for sharing video clips of video game action, comprising:
a processor processing player input and game action and creating video of the game action;
a memory operably connected to the processor and having stored thereon player selected settings for triggering video clip capture and settings for sharing video clips;
a memory operably connected to the processor and having a video clip sharing application encoded thereon, the video clip sharing application automatically capturing video clips in response to game actions meeting the triggering settings automatically sharing the video clips according to the sharing settings.

12. The system of claim 11, wherein the processor is a processor of a game server connected through a network to a plurality of game consoles.

13. The system of claim 11, wherein the processor is a processor of a game console connected through a network to a game server.

14. A program product for sharing video clips of video game action comprising a computer readable storage medium having encoded thereon a program of instructions, comprising:
program instructions for setting game action triggers for video clip capture;
program instructions for automatically capturing a video clip during a video game in response to triggering actions during playing of a game;
program instructions for automatically tagging recipients; and
program instructions for automatically sending the captured video clip to the tagged recipients.

15. The program product of claim 14, wherein at least one other player in the game is automatically tagged as a recipient based on the other player's display name.

16. The program product of claim 14, wherein the at least one other player in the game is tagged by querying the server for player information.

17. The program product of claim 14, wherein at least one individual not participating in the game is tagged as a recipient based on user preference settings.

18. The program product of claim 14, wherein the video clip is created by a winner of the video game and is automatically sent to the tagged recipients between games.

19. The program product of claim 14, wherein the video clip is automatically sent to the tagged recipients after the video game.

20. The program product of claim 14, wherein the video clip is automatically uploaded to a file-sharing web site and a link to the video clip is automatically sent to the tagged recipient.
